(19) United States
(12) Patent Application Publication
(10) Pub. No.: US 2012/0060707 A1
(43) Pub. Date: Mar. 15, 2012

(54) HOLOGRAM FORMING APPARATUS AND HOLOGRAM FORMING METHOD

(75) Inventors: Yasunori Chigono, Atsugi-shi (JP); Makoto Fukatsu, Suntou-gun (JP); Emi Hagiwara, Yokohama-shi (JP); Shintaro Ishida, Toda-shi (JP)

(73) Assignee: CANON KABUSHIKI KAISHA, Tokyo (JP)

(21) Appl. No.: 13/221,114

(22) Filed: Aug. 30, 2011

(30) Foreign Application Priority Data
Sep. 9, 2010 (JP) 2010-201847

(51) Int. Cl. B41F 19/02

(52) U.S. Cl. 101/27; 101/32

(57) ABSTRACT

The present invention provides a hologram forming apparatus, including: an embossed hologram sheet; a roller which forms a nip portion between the embossed hologram sheet and the roller, wherein a recording medium bearing a toner image is conveyed to the nip portion so that the toner image is brought into contact with the embossed hologram sheet, and the recording medium and the embossed hologram sheet are heated while being nipped and conveyed in the nip portion; a cooling portion for cooling the recording medium that has passed through the nip portion and is in a contact state with the embossed hologram sheet; and a separating portion for separating the recording medium from the embossed hologram sheet, the recording medium having passed through the cooling portion and bearing the toner image on which an embossed shape of the embossed hologram sheet is transferred.

### BACKGROUND OF THE INVENTION

1. Field of the Invention

The present invention relates to a hologram forming apparatus and a hologram forming method.

2. Description of the Related Art

Holography is abundant with visual effects and is used not only as means for recording three-dimensional information but also as decoration of various paper and film products. Conventionally, various hologram forming apparatuses and hologram forming methods have been proposed. Japanese Patent Application Laid-Open No. S60-254174 discloses a technology in which a hologram is transferred from a hologram original plate to a thermoformable curing type sheet by heating and pressing, and further ultraviolet ray or an electron beam is emitted to the back surface of the sheet so that the hologram transferred to the sheet is fixed. Japanese Patent Application Laid-Open No. 562-191872 discloses a technology in which a sheet, which has been formed into a sheet shape by an injection molding machine, is supplied to between a hologram original plate and an opposed cylinder, and is cooled after separation, to thereby form a hologram sheet. The conventional hologram forming apparatus and the conventional hologram forming method described above have the following problem.

Conventionally, it has been necessary to apply high pressure uniformly to the hologram original plate and recording medium when the hologram is transferred to the recording medium in order to transfer a fine hologram shape correctly. Therefore, a material that can be used for the recording medium has been limited to a film base material so as to enhance adhesiveness with the hologram original plate.

### SUMMARY OF THE INVENTION

The present invention provides a hologram forming apparatus and a hologram forming method in which hologram can be formed on various types of recording media with a simple structure without necessity of high pressure when the hologram is transferred from a hologram original plate to a recording medium.

The present invention provides a hologram forming apparatus, including: an embossed hologram sheet; a roller which forms a nip portion between the embossed hologram sheet and the roller, wherein a recording medium bearing a toner image is conveyed to the nip portion so that the toner image is brought into contact with the embossed hologram sheet, and the recording medium and the embossed hologram sheet are heated while being nipped and conveyed in the nip portion; a cooling portion for cooling the recording medium that has passed through the nip portion and is in a contact state with the embossed hologram sheet; and a separating portion for separating the recording medium from the embossed hologram sheet, the recording medium having passed through the cooling portion and bearing the toner image on which an embossed shape of the embossed hologram sheet is transferred.

The present invention provides a hologram forming method, including: forming a fixed toner image on a recording medium; conveying the recording medium bearing the fixed toner image to a nip portion of a hologram forming apparatus so that the toner image is brought into contact with an embossed hologram sheet, and heating the recording medium and the embossed hologram sheet while nipping and conveying in the nip portion; cooling the recording medium that has passed through the nip portion and is in a contact state with the embossed hologram sheet; and separating the recording medium from the embossed hologram sheet, the recording medium having passed through the cooling portion and bearing the toner image on which an embossed shape of the embossed hologram sheet is transferred.

Other objects of the present invention are apparent from the following detailed description with reference to the attached drawings.

Further features of the present invention will become apparent from the following description of exemplary embodiments with reference to the attached drawings.

### BRIEF DESCRIPTION OF THE DRAWINGS

FIG. 1 is a schematic structural diagram of a hologram forming apparatus according to an embodiment of the present invention.

FIG. 2 is a schematic structural diagram of an image forming apparatus.

FIG. 3 is a perspective view of an embossed hologram sheet.

FIG. 4 is an enlarged diagram of a region 1 of FIG. 3.

FIG. 5A illustrates a region B1 of FIG. 4 in detail.

FIG. 5B illustrates a region B2 of FIG. 4 in detail.

FIG. 6 illustrates a result of measuring a part of a surface shape of FIG. 5A.

### DESCRIPTION OF THE EMBODIMENTS

Embodiments of the present invention will now be described in detail in accordance with the accompanying drawings.

### Embodiments

<1: Schematic Structural Diagram of Hologram Forming Apparatus>

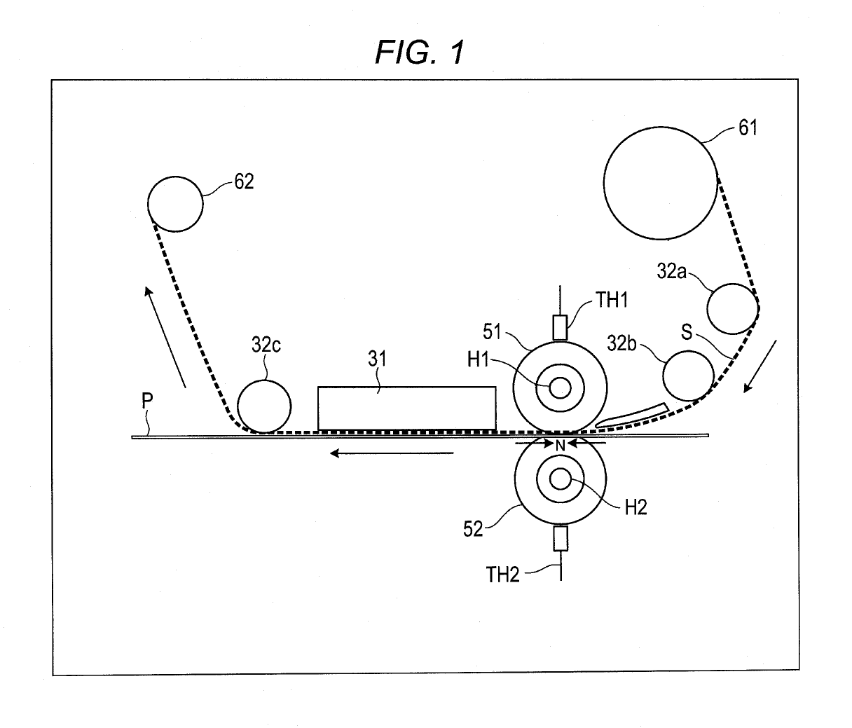

With reference to FIG. 1, a schematic structure of a hologram forming apparatus according to an embodiment is described. The hologram forming apparatus includes heating rollers 51 and 52 as a pair of rotary members disposed to be opposed to each other. These heating rollers are driven to rotate so that a surface traveling speed becomes 55 mm/s. The hologram forming apparatus according to the embodiment sends an original plate of the hologram (hereinafter, referred to as a hologram master S) and a recording material P to a nip portion N of the heating rollers. Then, the hologram forming apparatus brings the hologram master S and the recording material P into contact with each other in the nip portion N to be heated so that the hologram is transferred to a toner image forming surface of the recording medium P. More specifically, toner on the recording medium P is melted in the nip portion N of the heating rollers 51 and 52, and an embossed shape of the hologram master S is transferred to the melted part so that the hologram is formed on the recording medium P. In this embodiment, a hologram laminate sheet (embossed hologram sheet) manufactured by Coburn Japan Corporation is used as the hologram master S, and Aurora Coat manufactured by Nippon Paper Industries Co., Ltd. (having a basic weight of 157 g/m²) is used as the recording medium P.

The heating rollers 51 and 52 have a three-layer structure (a core part, an elastic layer, and a mold releasing layer) constituted concentrically. The core part is constituted of a hollow pipe made of aluminum having a diameter of 44 mm and a thickness of 5 mm, the elastic layer is constituted of a silicone rubber having JIS-A hardness of 50 degrees and a thickness of 3 mm, and the mold releasing layer is constituted of a PFA (tetrafluoroethylene-perfluoroalkyl vinyl ether copolymer) having a thickness of 50 μm. Inside the hollow pipes of the respective core parts, there are disposed halogen lamps H1 and H2 as heat sources. Temperature sensor elements TH1 and TH2 are disposed for the heating rollers 51 and 52, respectively. Based on the sensing results of the temperature sensor elements TH1 and TH2, a control portion (not shown) controls electric power to be supplied to the halogen lamps so that surface temperatures of the heating rollers 51 and 52 become predetermined target temperatures, respectively.

The hologram master S is stocked in film reels 61 and 62. The film reels 61 and 62 are respectively driven to rotate by drive sources (not shown). Between the film reels 61 and 62, there are disposed multiple conveyor rollers 32a to 32c. Thus, the hologram master S can move from the film reel 61 to the film reel 62 while suspended around the conveyor rollers 32a to 32c. A torque limiter is interposed between each of the drive sources and each of the film reels 61 and 62. Therefore, the hologram master S can maintain a constant tension.

In the moving process of the hologram master S, the hologram master S passes through the nip portion N of the heating rollers 51 and 52. Similarly, the recording medium P on which a toner image has been formed in advance by an image forming apparatus described later also passes through the nip portion N of the heating rollers 51 and 52 in the same direction as that of the hologram master S by a conveyance unit (not shown). Each of the heating rollers and 52 has elasticity. Therefore, by passing the hologram master S and the recording medium P through the nip portion N of the heating rollers 51 and 52, the hologram master S and the recording medium P can be heated while being brought into press contact with each other. The recording medium P is sent to the nip portion N so that the toner image forming surface is situated on the embossed hologram sheet side. In other words, a hologram forming surface (on which the embossed shape is formed) of the hologram master S and the toner image forming surface of the recording medium P contact with each other in the nip portion N.

In downstream of the nip portion N in a conveying direction of the recording medium P and the hologram master S, there is disposed a cooling member 31 for cooling the recording medium P and the hologram master S after being heated and passing through the nip portion N. The cooling member 31 includes multiple fins and a cooling fan, and hence the recording medium P and the hologram master S can be cooled down to approximately 30° C. by the cooling action. Through the cooling, the embossed shape can be securely formed on the recording medium P.

In the downstream of the cooling member 31, the conveyor roller 32c is disposed as a separating member for separating the recording medium P after cooling from the hologram master S. The conveyor roller 32c can convey the hologram master S and can separate the recording medium P from the hologram master S by its curved surface. At this time point, the recording medium P and the hologram master S are already cooled, and hence there is no risk that the embossed shape formed on the recording medium P collapses in the separation process.

<2: Schematic Structure of Image Forming Apparatus>

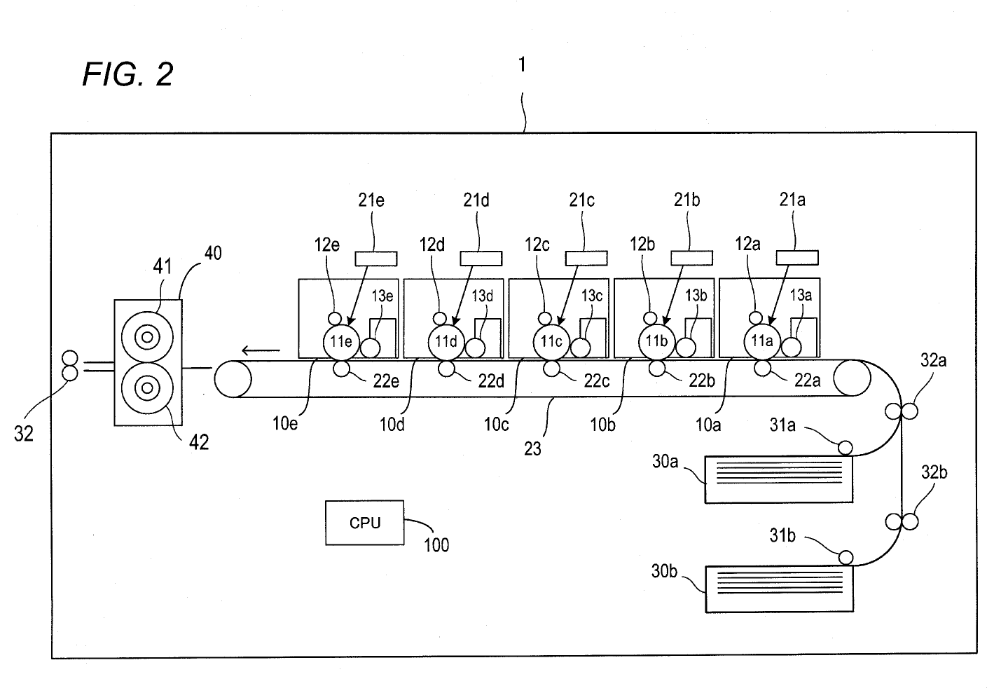

In the above-mentioned hologram forming apparatus, the hologram is transferred to the toner image forming surface of the recording medium P. This toner image can be formed by a known image forming apparatus. Hereinafter, with reference to FIG. 2, the image forming apparatus that can form a toner image on the recording medium P is described.

The image forming apparatus is a full color electrophotography image forming apparatus (tandem type color recording apparatus). An apparatus main body 1 of this image forming apparatus is connected to an external host device (not shown) such as a color image reading device or a personal computer. Various types of information signals such as image data are input from the external host device to a control portion (CPU) 100 of the apparatus main body 1, and image forming sequence control is executed based on this input information.

The apparatus main body 1 includes five, namely, first to fifth image forming portions (color stations: image forming units) 10a to 10e arranged in tandem from the right to left in FIG. 2. Below the five image forming portions 10a to 10e, a conveyor belt 23 that can rotate in an arrow direction is disposed. These image forming portions 10a to 10e include five types of developer, namely, yellow, magenta, cyan, black, and transparent developer. The type “transparent” indicates developer that contains no coloring agent and is transparent to visible light. The image forming portions 10a to 10e have the same structure and the same image forming process while only the color of the corresponding (contained) developer is different among the image forming portions 10a to 10e.

The individual image forming portions are respectively provided with drum type electrophotographic photosensitive members (hereinafter, referred to as drums) 11a to 11e as image bearing members that are driven to rotate by a drive unit (not shown) at a predetermined speed. Around the drums 11a to 11e, there are disposed primary chargers 12a to 12e for charging surfaces of the drums 11a to 11e, respectively, with a predetermined polarity and potential uniformly, and exposure devices 21a to 21e for exposing the uniformly charged surfaces of the drums 11a to 11e so as to form electrostatic latent images. Further, there are disposed developing members 13a to 13e for developing the electrostatic latent images formed on the drums 11a to 11e to toner images by supplying toner, and primary transferring rollers 22a to 22e that are disposed to be opposed to the drums 11a to 11e via the conveyor belt 23.

When a toner image is to be formed on the recording medium P, the recording media P are fed one by one by feed rollers 31a and 31b from feed portions 30a and 30b in which the recording media P are stored. The fed recording medium P is carried by the conveyor belt 23 via the conveyor rollers 32a and 32b. The recording medium P carried by the conveyor belt 23 is conveyed to the nip portions between the photosensitive drums 11a to 11e and the primary transferring rollers 22a to 22e at appropriate timings, and toner images from the drums 11a to 11e are transferred to be superimposed each other at the individual nip portions. In this case, toner remaining on the drums 11a to 11e after the primary transferring is removed from the drums 11a to 11e by a cleaning member (not shown). The process speed is set to 110 mm/s.

The recording medium P to which the toner image is transferred is conveyed to a fixing device 40, and is heated and pressed by the fixing device 40. Thus, the unfixed toner image is fixed on the recording medium P (fixing process). The fixing device 40 includes a fixing roller 41 (fixing rotary member) having a heater (heating member) provided inside, and a pressure roller 42 as a pressing member. The fixing roller 41 and the pressure roller 42 are brought into press-contact with each other so that a fixing nip portion is formed. Here, thermal control is performed so that surface temperature of the fixing roller 41 is 175° C. The recording medium P on which the toner image is fixed is delivered by a delivery roller 32 from the image forming apparatus, and is conveyed to the hologram forming apparatus. Thus, the step of forming the toner image on the recording medium P is completed.

In the above, the image forming method of forming the toner image directly on the recording medium P carried by the conveyor belt 23 is described, but other image forming method may be adopted. For instance, an intermediate transferring method may be adopted in which the toner image is primarily transferred to an intermediate transferring belt, and then the toner image is secondarily transferred from the intermediate transferring belt to the recording medium. The fixing device 40 may be a thermal roller type fixing device including a fixing roller and a pressing member, or a surf type fixing device including a flexible fixing sleeve and a pressing member. Conditions for the image formation, such as power to be supplied to the heat source of the fixing device 40 and convey speed of the recording medium P, are controlled by the control portion (CPU) 100 of the apparatus main body 1.

<3: With Regard to Developer>

The colored developer used in this embodiment is described. In this embodiment, toner particles containing a binder resin, a coloring agent, and wax are used as the colored developer.

General binder resins may be used in the binder resin. Although no limitation is intended, any one of a hybrid resin containing a polyester unit and a vinyl polymer unit, a polyester resin, a vinyl polymer, and mixture of these resin can be used. The binder resin may have a peak molecular weight (Mp) of 4,000 to 10,000 in a molecular weight distribution measured by gel permeation chromatography (GPC), and a ratio (Mw/Mn) between a weight average molecular weight (Mw) and a number average molecular weight (Mn) can be 300 or larger. The ratio Mw/Mn can be 500 or larger. The molecular weight distribution can be adjusted by the polymerization condition of the binder resin or the mixing of the binder resin having appropriate average molecular weights.

Known pigments and/or dyes may be used as the coloring agent. Examples of the coloring agent include: black coloring agents including carbon black, acetylene black, lamp black, graphite, iron black, aniline black, and cyanine black; magenta coloring pigments including C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 163, 202, 206, 207, 209, or 238, C.I. Pigment Violet 19, and C.I. Vat Red 1, 2, 10, 13, 15, 23, 29, or 35; magenta dyes including oil-soluble dyes such as C.I. Solvent Red 1, 3, 8, 23, 24, 25, 27, 30, 49, 81, 82, 83, 84, 100, 109, or 121, C.I. Disperse red 9, C.I. Solvent Violet 8, 13, 14, 21, or 27, and C.I. Disperse Violet 1, and basic dyes such as C.I. Basic Red 1, 2, 9, 12, 13, 14, 15, 17, 18, 22, 23, 24, 27, 29, 32, 34, 35, 36, 37, 38, 39, or 40, and C.I. Basic Violet 1, 3, 7, 10, 14, 15, 21, 25, 26, 27, or 28; cyan coloring pigments including C.I. Pigment Blue 2, 3, 15:1, 15:2, 15:3, 16, or 17, C.I. Acid Blue 6, C.I. Acid Blue 45, and copper phthalocyanine pigments each having a phthalocyanine skeleton substituted by 1 to 5 phthalimidomethyl groups; and yellow coloring pigments including C.I. Pigment Yellow 1, 2, 3, 4, 5, 6, 7, 10, 11, 12, 13, 14, 15, 16, 17, 23, 65, 73, 74, 83, 93, 97, 155, or 180, and C.I. Vat Yellow 1, 3, or 20. The used amount of the coloring agent is 3 to 20 parts by weight, or can be 6 to 10 parts by weight with respect to 100 parts by weight of the binder resin in view of a balance between reproducibility of an intermediate color and coloring power.

Known waxes may be used as the wax. Examples of the wax include: aliphatic hydrocarbon waxes such as polyolefin wax, low molecular weight polyethylene, low molecular weight polypropylene, microcrystalline wax, Fischer-Tropsch wax, and paraffin wax; oxides of aliphatic hydrocarbon waxes such as oxidized polyethylene wax; block copolymers thereof; waxes each containing a fatty acid ester as a main component such as carnauba wax and montanic acid ester wax; and partially or wholly deacidified fatty acid esters such as deacidified carnauba wax.

In addition to the foregoing, further examples of the wax include: saturated linear fatty acids such as palmitic acid, stearic acid, and montanic acid; unsaturated fatty acids such as brassidic acid, eleostearic acid, and parinaric acid; saturated alcohols such as stearyl alcohol, aralkyl alcohol, behenyl alcohol, carnaubyl alcohol, ceryl alcohol, and melissyl alcohol; polyhydric alcohols such as sorbitol; fatty acid amides such as linoleic acid amide, oleic acid amide, and lauric acid amide; saturated fatty acid bisamides such as methylenebisstearic acid amide, ethylenebiscapric acid amide, ethylenebislauric acid amide, and hexamethylenebisstearic acid amide; unsaturated fatty acid amides such as ethylenebisoleic acid amide, hexamethylenebisoleic acid amide, N,N′-dioleyladipic acid amide, and N,N-dioleylsebacic acid amide; aromatic bisamides such as m-xylenebisstearic acid amide and N,N′-distearylisophthalic acid amide; fatty acid metal salts generally called metallic soaps, such as calcium stearate, calcium laurate, zinc stearate, and magnesium stearate; waxes obtained by grafting vinyl monomers such as styrene and acrylic acid onto aliphatic hydrocarbon waxes; partially esterified products of fatty acids and polyhydric alcohols such as behenic acid monoglyceride; and methyl ester compounds each having a hydroxyl group obtained by hydrogenating vegetable fat and oil.

The wax is 0.1 to 20 parts by weight with respect to 100 parts by weight of the binder resin, or can be 0.5 to 10 parts by weight. The wax can be contained in the toner particles usually by a method of, after dissolving the binder resin in a solvent and raising temperature of the binder resin solution, adding and mixing the wax in the binder resin solution while stirring, or a method of mixing the wax when the material of the toner particles is mixed and kneaded.

A known external additive can be added to the developer to control fluidity and developing property. As the external additive, there can be used various types of inorganic oxide fine particles such as silica, alumina, titanium oxide, or cerium oxide, fine particles subjected to hydrophobic process as necessary, vinyl polymer, zinc stearate, resin fine particles, and the like. An additive amount of the external additive can be within the range from 0.02% to 5% by weight with respect to the toner particles.

The colored developer is described above, and next, the transparent developer is described. The transparent developer refers to non-colored toner (also referred to as transparent toner) that is transparent to visual light and is formed without using coloring agent in the above-mentioned toner forming method. On the recording medium P, the transparent toner is formed on the colored toner. Therefore, the transparent toner is required to have sufficient transparency. A maximum density of the transparent toner per unit thickness (Amax) was measured, and a result of the measurement was 0.015. The transparent toner having Amax of 0.001 to 0.1 can be used.

<4: Verification of Effects>

In order to verify effects of the hologram forming apparatus and the hologram forming method according to this embodiment, forming states of the hologram were examined in respective conditions while changing presence or absence of the wax in the developer, presence or absence of oil coated on the surface of the fixing roller (or the fixing sleeve), temperature of heating rollers 51 and 52, and the like. Specifically, in each condition, hologram transferring property, hologram rewriting property, hologram preserving property, occurrence of air bubble/offset were examined.

### Example 1

The developer containing wax was used, and temperature of the heating rollers 51 and 52 was adjusted to 135° C.

### Example 2

In addition to the condition of Example 1, the above-mentioned transparent toner was used for image formation. The whole of the recording medium P was covered with one of the colored toner and the transparent toner without leaving a blank part in the image formation.

### Example 3

In addition to the condition of Example 1, a sheet member having a surface coated with a resin was used as the recording medium P. Here, glossy special paper with precoated resin was used. The glossy special paper includes a base having at least one surface of a pigment applied layer whose main components are adhesive and pigment, and a resin layer whose main component is a thermoplastic resin, which is formed on the pigment applied layer. As the thermoplastic resin, a polyester resin, styrene-acrylic acid ester, styrene-methacrylic acid ester, and the like can be used. In particular, the polyester resin can be used. Here, hologram was transferred with using glossy special paper having a basis weight of 150 g/m², in which pigment was applied to both sides of base paper having a basis weight of 127 g/m², and the polyester resin was applied to one side to have a thickness of 15 μm.

### Example 4

The temperature of the heating rollers 51 and 52 was adjusted to be 125° C. in the condition of Example 1.

### Example 5

The temperature of the heating rollers 51 and 52 was adjusted to be 155° C. in the condition of Example 1.

### Example 6

In addition to the condition of Example 1, air holes were formed in the hologram master S with density of 4 holes per square centimeters. The air holes were formed by using an edge of a sharp blade.

### Example 7

The developer without wax was used, and a toner image was formed on the recording medium P by the image forming apparatus including the fixing roller 41 to which a slight amount of silicone oil (mold release agent) was applied for enhancing the mold releasing property. An image sample was formed by CLC1100 series (manufactured by CANON Inc.). The recording medium P on which the toner image was formed in that way was heated by the heating rollers 51 and 52 whose surface temperature was adjusted to 135° C. Application amount of the silicone oil from the surface of the fixing roller 41 to the recording medium P was 0.3 g/m².

### Example 8

The developer without wax was used, and a toner image was formed on the recording medium P by the image forming apparatus including the fixing roller 41 to which a slight amount of silicone oil was applied for enhancing the mold releasing property. The recording medium P on which the toner image was formed in that way was heated by the heating rollers 51 and 52 whose surface temperature was adjusted to 135° C. Application amount of the silicone oil from the surface of the fixing roller 41 to the recording medium P was 1.0 g/m².

### Example 9

In addition to the condition of Example 1, instead of performing fixing of the toner image in the image forming apparatus, both the fixing operation and transferring of the hologram were performed in the hologram forming apparatus.

### Comparative Example 1

As a comparative example of the above-mentioned Examples 1 to 9, the developer containing wax was used, and the temperature of the heating rollers 51 and 52 was adjusted to be 115° C. for transferring the hologram.

A result of comparison is shown in the table below. An evaluation basis is as follows. In the “hologram transferring property”, “GOOD” indicates that a hologram pattern can be clearly identified by eyes. “NORMAL” indicates that the hologram pattern can be identified by eyes (allowable level). “BAD” indicates that the hologram pattern cannot identified by eyes.

The “hologram rewriting property” indicates whether or not a first hologram does not remain so that only a second hologram is formed. The hologram rewriting property is examined at the following timing in which the first hologram is formed on a toner surface of the recording medium by the hologram forming apparatus to which the first hologram original plate is attached, and then, the first hologram original plate is replaced with the second hologram original plate having concavity and convexity of a surface different from that of the first hologram original plate, and the recording medium on which the first hologram had been formed was processed again (rewritten) by the hologram forming apparatus. “GOOD” indicates that only the second hologram can be clearly identified by eyes after the rewriting. “NORMAL” indicates that the second hologram can be identified by eyes (allowable level) after the rewriting. “BAD” indicates that the second hologram cannot be identified by eyes (because the first hologram remains) after the rewriting.

The “hologram preserving property” indicates whether or not the hologram image can be reproduced after a fingerprint put onto the hologram image is wiped off by a waste cloth. “GOOD” indicates that the hologram is the same as before the fingerprint is put on. “NORMAL” indicates that the hologram can be identified but is inferior to that before the fingerprint is put on (allowable level). “BAD” indicates that the hologram image cannot be identified by eyes.

The “air bubble/offset” indicates presence or absence of a circular transferring defect in a blank background (an exposed part of the recording medium) and presence or absence of toner adhesion to the film. The “air bubble/offset” was examined after that the checkered pattern of 10 mm×10 mm was formed as an image pattern, and then, the image formation and the hologram transferring were performed. “GOOD” indicates that the hologram transferring defect cannot be identified by eyes with respect to an image sample toner part, and that offset toner cannot be identified on the film. “NORMAL” indicates that a hologram transferring defect can be identified by eyes with respect to the image sample toner part or that the offset toner can be identified on the film. “BAD” indicates that the hologram transferring defect can be identified by eyes with respect to the image sample toner part and that the offset toner can be identified on the film.

TABLE 1

| | | | Heating | | | | | |
|---|---|---|---|---|---|---|---|---|
| | Presence | | roller | | Hologram | Hologram | Hologram | Air |
| | or absence | Application | temperature | Other | transferring | rewriting | preserving | bubble/ |
| | of Wax | of oil | (° C.) | features | property | property | property | offset |
| Example 1 | Present | Not applied | 135 | | GOOD | GOOD | GOOD | NORMAL |
| Example 2 | Present | Not applied | 135 | Transparent | GOOD | GOOD | GOOD | GOOD |
| | | | | toner | | | | |
| Example 3 | Present | Not applied | 135 | Resin coat | GOOD | GOOD | GOOD | GOOD |
| | | | | paper | | | | |
| Example 4 | Present | Not applied | 125 | | GOOD | GOOD | NORMAL | NORMAL |
| Example 5 | Present | Not applied | 155 | | GOOD | GOOD | GOOD | NORMAL |
| Example 6 | Present | Not applied | 135 | With air | GOOD | GOOD | GOOD | GOOD |
| | | | | holes | | | | |
| Example 7 | Absent | Applied | 135 | | GOOD | GOOD | GOOD | BAD |
| | | (little) | | | | | | |
| Example 8 | Absent | Applied | 135 | | NORMAL | GOOD | GOOD | BAD |
| Example 9 | Present | Not applied | 135 | Without | NORMAL | GOOD | GOOD | NORMAL |
| | | | | temporary | | | | |
| | | | | fixing | | | | |
| Comparative | Present | Not applied | 115 | | BAD | — | — | — |
| Example 1 | | | | | | | | |

In Example 1, some air bubbles and offset could be identified, but the “hologram transferring property”, the “hologram rewriting property”, and the “hologram preserving property” were all in good levels.

In Example 2, the recording medium P is covered with one of the colored toner and the transparent toner. Therefore, adhesion between the hologram master S and the recording medium P can be a certain level or higher so that the air bubbles can be prevented from growing and the toner offset can be prevented from occurring.

In Example 3, the recording medium P whose surface is coated with resin is used. Therefore, adhesiveness between the hologram master S and the recording medium P can be a certain level or higher so as to prevent the air bubbles from growing and the toner offset from occurring.

In Example 4, the “hologram transferring property” and the “hologram rewriting property” were in good levels, but the “hologram preserving property” was inferior to that in Example 1 to Example 3. In Example 4, the temperature of the heating rollers 51 and 52 is 125° C. Therefore, among substances constituting the developer, a low melting point substance (for example, wax) is melted, but a high melting point substance is not melted.

Therefore, it is conceived that Example 4 has a disadvantage in the “hologram preserving property” compared with Examples 1 to 3.

In Example 5, similarly to Examples 1 to 3, the “hologram transferring property”, the “hologram rewriting property”, and the “hologram preserving property” were all in good levels, but growth of the air bubbles and occurrence of the offset were identified. In Example 5, the temperature of the heating rollers 51 and 52 is 155° C. Therefore, among substances constituting the developer, also a high melting point substance is melted, and thus adhesiveness to the hologram master S is enhanced. However, it is conceived that the air bubbles grow due to the offset and moisture generated by heating.

In Example 6, because air holes are formed in the hologram master S, it is possible to discharge the moisture that causes the air bubbles through the air holes from the hologram master S side. Therefore, it is possible to keep the “hologram transferring property”, the “hologram rewriting property”, and the “hologram preserving property” to be in good levels and to suppress growth of the air bubbles and occurrence of the offset.

In Example 7, growth of the air bubbles and occurrence of the offset were identified, but the “hologram transferring property”, the “hologram rewriting property”, and the “hologram preserving property” were in good levels.

In Example 8, compared with Example 7, the “hologram transferring property” was inferior as a result.

In Example 8, it is conceived that, because a lot of silicone oil is applied from the fixing roller to the recording medium P, the fine uneven shape of the hologram is filled with the silicone oil on the recording medium P when the hologram is transferred, and hence the “hologram transferring property” becomes inferior. From this result, it can be said that a good result is obtained in the case that the application amount of the silicone oil from the fixing roller 41 to the recording medium P is 1.0 g/m² or less.

In Example 9, compared with Example 1, the “hologram transferring property” was slightly decreased, but the “hologram rewriting property” and the “hologram preserving property” were in good results.

In Comparative Example 1, the hologram could not be identified on the recording medium P by eyes. The reason is considered to be that, in Comparative Example 1, the temperature of the heating rollers 51 and 52 is set to be low as 115° C., and therefore the toner image formed on the recording medium P cannot be sufficiently melted. In other words, because the hologram forming apparatus according to this embodiment has a structure in which the toner image on the recording medium P is sufficiently melted, and the hologram is transferred onto the melted toner, it is difficult to transfer the hologram onto the surface on which the toner image is not sufficiently melted.

<5: Effect of this Embodiment>

According to this embodiment, in the nip portion of the heating roller pair, the recording medium P is heated by a temperature equal to or higher than melting temperature of the toner image, and the hologram is transferred to the melted part. After that, the recording medium P is cooled to obtain the hologram. Conventionally, a large pressure has been necessary for the transferring, and therefore a large scale transferring system has been necessary. However, according to this embodiment, a large pressure is not necessary for the transferring. Therefore, the hologram can be transferred with a simple structure.

Because the toner is melted, adhesiveness between the hologram original plate and the recording medium can be enhanced without using a film-like recording medium. Therefore, selection range of the material that can be used as the recording medium can be widened. For instance, it is possible to use recording paper as the recording medium and to transfer the hologram after forming the toner image on the recording paper.

The temperature of the heating roller when the hologram is transferred is only required to be equal to or higher than a temperature at which at least the toner image starts melting. As described above, according to this embodiment, it is possible to provide a hologram forming apparatus and a hologram forming method in which hologram can be recorded on various types of recording media with a simple structure without necessity of high pressure when the hologram is transferred from a hologram original plate to a recording medium.

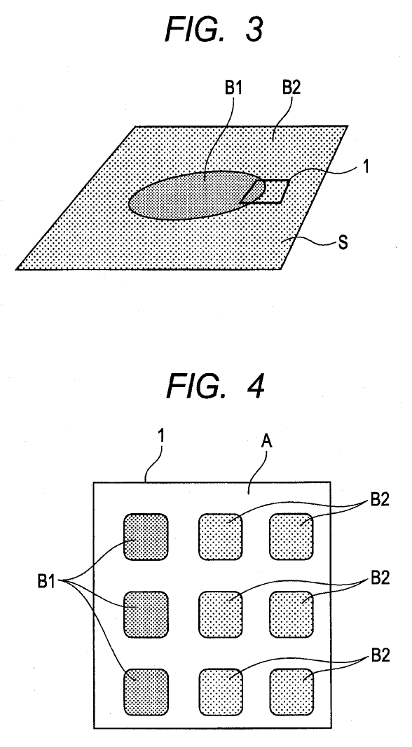

Next, a fine shape of the surface of the embossed hologram sheet S is described. FIG. 3 is a perspective view of the embossed hologram sheet with a “circle” design. Using an embossed hologram sheet having a fine grating shape (embossed shape) on the surface, the grating shape is transferred to the surface of the toner image. Thus, it is possible to provide a rainbow visual effect (holography effect) utilizing light interference to the toner image after being processed by the hologram forming apparatus. The surface of the embossed hologram sheet has different grating angles in individual areas, and a target design (circle shape in the example of FIG. 3) appears on a toner image surface after being passed through the hologram forming apparatus.

FIG. 4 illustrates an enlarged diagram of a region 1 illustrated in FIG. 3. As illustrated in FIG. 4, the region 1 includes a region A in which the grating is not formed and a region B in which the grating is formed. The region B includes a region B1 and a region B2 having a grating angle different from that of the region B1. An area ratio between the region A and the region B (sum of regions B1 and B2) is adjusted according to the material or the target design. In this example, the ratio is set to 1:1.

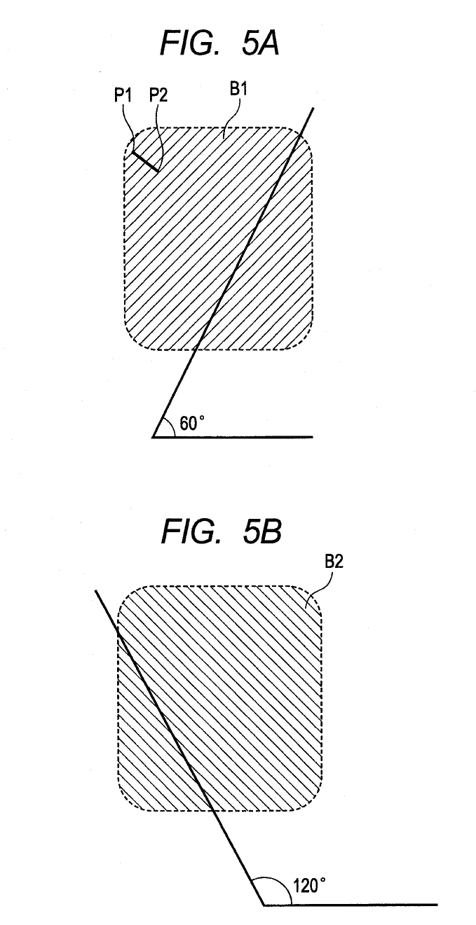

Details of the region B1 and the region B2 are illustrated in FIGS. 5A and 5B. In both of the regions, the grating is formed with a constant pitch in a constant direction, and the angle is different between the regions B1 and B2. By changing the angle, the circular design can be observed when the toner image after being processed by the hologram forming apparatus is observed.

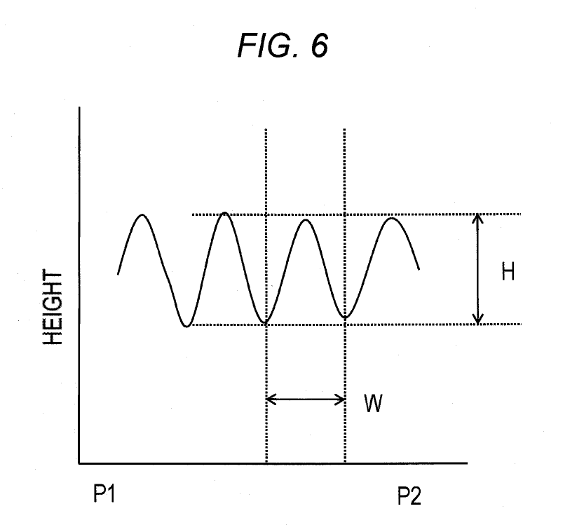

FIG. 6 illustrates a result of measuring the surface shape of a part (between points P1 and P2) of FIG. 5A. A grating height H was 100 nm, and a width W was 1 μm. In order to obtain the holography effect on the toner image surface after being passed through the hologram forming apparatus, the grating height H of the embossed hologram sheet surface can be set to 100 to 400 nm, and the width W to 0.5 to 2 μm.

<6: Another Embodiment>

The above-mentioned embodiment describes the case where the halogen lamps H1 and H2 as the heat sources are disposed in both of the heating rollers 51 and 52, but it is sufficient if the heat source is disposed in at least one of the heating rollers. In other words, it is possible to adopt the structure in which the heat source is disposed in only one of the heating rollers as long as the temperature for sufficiently melting the toner image formed on the recording medium P can be realized in the nip portion of the heating roller pair.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-201847, filed Sep. 9, 2010, which is hereby incorporated by reference herein in its entirety.

What is claimed is:

1. A hologram forming apparatus, comprising:
an embossed hologram sheet;
a roller which forms a nip portion between the embossed hologram sheet and the roller, wherein a recording medium bearing a toner image is conveyed to the nip portion so that the toner image is brought into contact with the embossed hologram sheet, and the recording medium and the embossed hologram sheet are heated while being nipped and conveyed in the nip portion;
a cooling portion for cooling the recording medium that has passed through the nip portion and is in a contact state with the embossed hologram sheet; and
a separating portion for separating the recording medium from the embossed hologram sheet, the recording medium having passed through the cooling portion and bearing the toner image on which an embossed shape of the embossed hologram sheet is transferred.

2. A hologram forming apparatus according to claim 1, further comprising a backup roller which is brought into contact with a surface opposite to a contact surface of the embossed hologram sheet with the toner image, so as to form the nip portion together with the roller.

3. A hologram forming apparatus according to claim 1, wherein the embossed hologram sheet is provided with air holes.

4. A hologram forming method, comprising:
forming a fixed toner image on a recording medium;
conveying the recording medium bearing the fixed toner image to a nip portion of a hologram forming apparatus so that the toner image is brought into contact with an embossed hologram sheet, and heating the recording medium and the embossed hologram sheet while nipping and conveying in the nip portion;
cooling the recording medium that has passed through the nip portion and is in a contact state with the embossed hologram sheet; and
separating the recording medium from the embossed hologram sheet, the recording medium having passed through the cooling portion and bearing the toner image on which an embossed shape of the embossed hologram sheet is transferred.
